(19) United States
(12) Patent Application Publication
(10) Pub. No.: US 2007/0074233 A1
(43) Pub. Date: Mar. 29, 2007

(54) Information reproducing apparatus

(76) Inventors: Toshiyuki Moriya, Tokorozawa (JP); Hidenori Shinohara, Hitachinaka (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/476,728

(22) Filed: Jun. 29, 2006

(30) Foreign Application Priority Data
Sep. 29, 2005 (JP) 2005-283266

(51) Int. Cl. G11B 33/02

(52) U.S. Cl. 720/647

(57) ABSTRACT

An information reproducing apparatus accepts a recording disc into the apparatus via an ejectable tray for reproducing information. An inclined face, which is inclined downward, is formed before a disc recording/reproducing unit having the ejectable tray. On this inclined face, a door is provided that configures the inclined face when the door is closed and that forms a movement path of the tray by lowering a back part of the inclined face inward when the door is opened.

### INCORPORATION BY REFERENCE

The present application claims priority from Japanese application JP2005-283266 filed on Sep. 29, 2005, the content of which is hereby incorporated by reference into this application.

### BACKGROUND OF THE INVENTION

The present invention relates to an information reproducing apparatus that records or reads various types of information to or from a disc by inserting or ejecting the disc, placed on a tray, via an opening.

Recently, as the capacity of a recording disc such as a CD and a DVD is increased, it has become common to store or reproduce music information, video information, and even various types of programs and data to or from this recording disc.

A disc reproducing unit that reproduces information from such a recording disc is constructed as a standalone unit that is built into the casing of a video reproducing apparatus or a personal computer to allow a large-capacity recording/reproducing unit to be installed easily in various apparatuses.

A disc reproducing unit constructed as a standalone unit usually has a motor-driven, ejectable tray on the front of a box-shaped casing. A DVD or a CD placed on this tray is inserted into the casing for recording or reproduction.

The disc reproducing unit described above is built in various apparatuses having a box-shaped casing. For example, a DVD player usually has a low-profile, flat, and box-shaped body, with the medium-insertion opening such as a disc insertion slot, the operation switches, and the display concentrated on the front of the body, and with the terminals for connection to various devices provided on the back of the body. This is a standard structure usually used for the body a personal computer. This structure is employed because a DVD player is usually mounted on a TV rack, placed under a desk, or stacked one on top of the other similarly structured devices.

[Patent Document 1] JP-A-2005-190580

[Patent Document 2] JP-A-2002-311512

In the prior art technology described above, the tray is ejected out of the box-shaped apparatus casing, sometimes causing accidental damage to the tray. Because a conventional DVD player or a CD player is stacked in a TV rack or an audio rack with other system apparatuses, the problem of this damage is not so serious. However, a recent DVD player, which is usually used as a standalone system component, can be installed in various ways and, depending on how it is installed, the damage described above becomes a serious problem.

To solve the problem described above, the photographic processing device disclosed in the JP-A-2002-311512 given above has a protective member for protecting the tray that is ejected. However, though efficient in a structure where a recording/reproducing unit is recessed below a worktable, the protective member in the prior art obstructs the handling of the body of a DVD player or a personal computer.

### SUMMARY OF THE INVENTION

In view of the foregoing, it is an object of the present invention to provide an information reproducing apparatus that protects the tray ejected from the disc unit from being damaged and that can be installed in various environments.

To achieve the above object, an information reproducing apparatus according to the present invention accepts a recording disc into the apparatus via an ejectable tray for reproducing information. An inclined face, which is inclined downward, is formed before a reproducing disc unit having the ejectable tray. On this inclined face, a door is provided that configures the inclined face when the door is closed and that forms a movement path of the tray by lowering a back part of the inclined face inward when the door is opened.

In addition, to achieve the above object, an information reproducing apparatus according to the present invention reproduces information from a recording disc inserted into a disc recording/reproducing unit provided inside a casing via an ejectable tray. The casing has a low profile, flat external shape whose depth size is longer than a height size and whose width size is longer than a depth size. The front of the casing comprises a top inclined face, which is inclined downward from a back to a front of a top of the casing, and a bottom inclined face which is inclined upward from a back to a front of a bottom of the casing. The top inclined face at least has a door that configures the top inclined face when the door is closed and that forms a movement path of the tray by lowering a back part of the top inclined face into an inside of the casing when the door is opened.

The information reproducing apparatus according to the present invention prevents the tray ejected from the disk unit from being damaged and can be installed in various environments.

Other objects, features and advantages of the invention will become apparent from the following description of the embodiments of the invention taken in conjunction with the accompanying drawings.

### BRIEF DESCRIPTION OF THE DRAWINGS

FIGS. 1A-1B are diagrams showing the external view of a DVD recorder in an embodiment of the present invention.

FIG. 2 is a diagram showing the layout of internal units of the DVD recorder.

FIGS. 3A-3E are diagrams showing the external view of the DVD recorder.

FIG. 4 is a diagram showing the cooling structure of the DVD recorder.

FIGS. 5A-5B are diagrams showing the cooling passage of the DVD recorder.

FIG. 6 is a diagram showing the general cross section of a tray movement path.

FIGS. 7A-7B are diagrams showing the general structure of a door driving unit.

FIG. 8A-8C are diagrams showing the operation process of the door driving unit.

FIG. 9 is a flowchart showing the tray ejection operation.

FIG. 10 is a flowchart showing the tray storing operation.

FIGS. 11A-11B are diagrams showing the external view of the surrounding of a sub recording/reproducing unit.

FIGS. 12A-12B are diagrams showing the external view of the surrounding of a sub external terminal part.

FIG. 13 is a diagram showing the installation state of the DVD recorder.

FIG. 14 is a diagram showing the installation state of the DVD recorder.

FIGS. 15A-15B are diagrams showing the installation state of the DVD recorder.

FIGS. 16A-16B are diagrams showing the installation state of the DVD recorder.

FIGS. 17A-17C are diagrams showing the installation state of the DVD recorder.

### DETAILED DESCRIPTION OF THE EMBODIMENTS

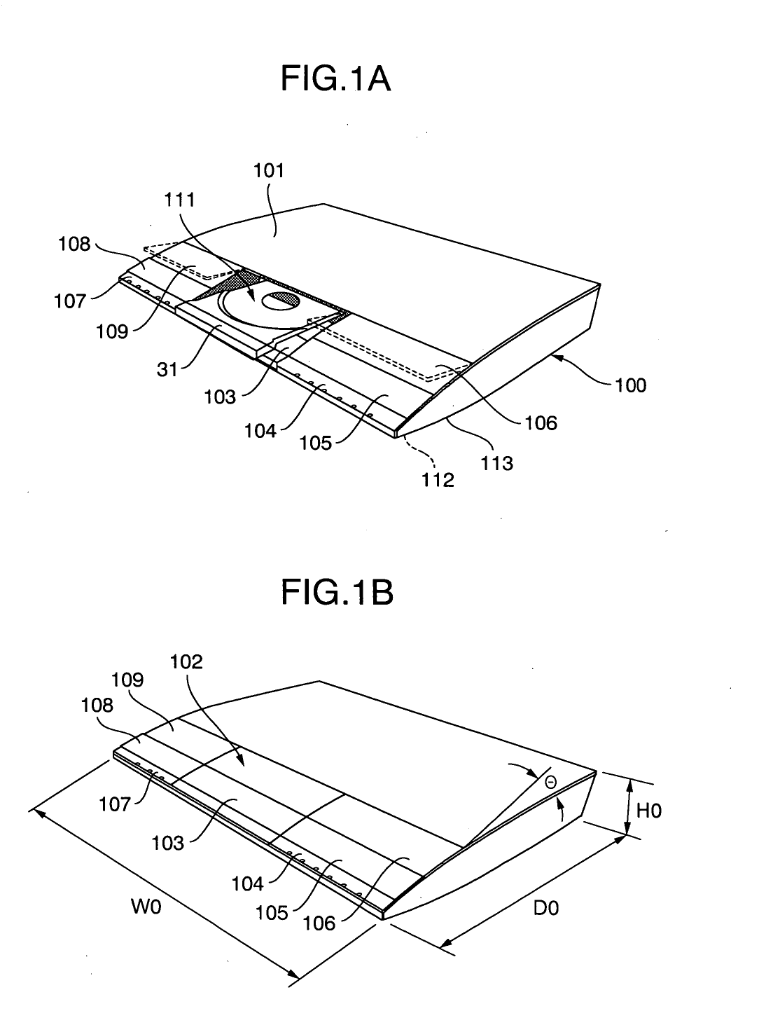

A DVD recorder, one embodiment of an information reproducing apparatus according to the present invention, will be described in detail below with reference to FIGS. 1A-1B to FIGS. 17A-17C. In the drawings, the same reference numerals denote the same structural elements and repetitive description will not be given.

First, with reference to FIGS. 1A-1B, the following describes the general structure of the DVD recorder in this embodiment. FIG. 1A is an external perspective view of the recorder with the tray ejected, and FIG. 1B is an external view of the recorder with the tray stored in the recorder.

In FIGS. 1A-1B, the DVD recorder in this embodiment internally has a disc recording/reproducing unit with a tray 31 for a medium such as a DVD (Digital Versatile Disk) or CD (Compact Disc), an internal recording/reproducing unit such as an HDD (Hard Disk Drive), and a sub recording/reproducing unit that records and reproduces data to and from various types of recording media.

This DVD recorder has a low-profile, flat casing 100 whose depth size D0 is longer than the height size H0 and whose width size W0 is longer than the depth size D0. This casing 100 is structured in such a way that the back part of a casing top 101 becomes flat to form a horizontal face and the front part of the casing top 101 is an inclined face 102 that is inclined downward.

The inclined face 102 is divided horizontally into three. A first door 103, which is opened and closed when a DVD is mounted or removed, is provided in the central part. One side is divided longitudinally into three with a first operation panel 104 provided in the front part, a first display panel 105 in the center, and a second door 106 for a sub recording/reproducing unit in the back part. The other side is also divided longitudinally into three, with a second operation panel 107 in the front part, a second display panel 108 in the center, and a third door 109 for a sub external terminal board in the back part.

In this embodiment, the bottom face of the casing 100, which is opposed to the inclined face 102, forms a bottom inclined face 113 that rises in the forward direction. Thus, the casing 100 has a shape characterized by the sides that get acute in the forward direction.

One of the features of the DVD recorder in this embodiment is that the front of the casing 100 is formed as a inclined face that is inclined downward and that the functional parts operated by the user, such as the entrance/exit of various media, the operation part, and the display part are concentrated on this inclined face 102. On a conventional apparatus like this recorder, the functional part is concentrated on the front of the box-shaped casing. This structure makes it easy to stack the apparatus in a TV rack with other apparatuses. However, in the recent Western way of life where people sit on chairs and the apparatus is sometimes placed just above the floor face, this structure degrades the visibility of the display and operability of the apparatus.

In this embodiment, the functional part via which the user operates the apparatus or views the display is concentrated, not on the vertical face as on a conventional apparatus, but on the inclined face 102 in the top to suit the way of life where people sit on chairs and their eye and postural level are high. In addition, this inclined face 102 on the top, provided in the front part of the casing 100, ensures good operability and visibility even if the apparatus is stored in a rack.

The functional part that has good operability and visibility, if provided on the vertical face, would increase the size of the vertical face on which the functional part is provided. Because the width of this type of apparatus is limited, a large vertical face requires a long height size and therefore it becomes difficult to make the apparatus low profile even if the internal mechanism is downsized.

In contrast, in this embodiment, the vertical face on which the functional part is conventionally concentrated is changed to an inclined face that is inclined backward. As compared with the vertical face, the inclined face is wider and makes it easier to make the apparatus low profile.

In this embodiment, the angle of inclination θ of the top inclined face 102 is set to about 20 degrees.

One of the most salient characteristics of this embodiment is that a disc entrance 111 of the disc recording/reproducing unit is provided on the top inclined face 102. This disc entrance 111 is opened by pulling in the first door 103, which configures the top inclined face 102, into the inside of the casing 100. More specifically, the back part of the first door 103, which stands higher than the front part, is pulled into the inside to form a gap between the casing top 101 and the first door 103. This gap is the disc entrance 111 used to pull out the tray 31.

This structure causes the tray 31, which goes into or out the disc entrance 111, moves above the first door 103. Thus, because the movement path of the tray 31 is provided by the first door 103, the tray 31 is less likely damaged when ejected. Especially, the movement path of the tray 31 is limited to the project area of the first door 103 in this embodiment and, therefore, the possibility of damage to the ejected tray 31 is further reduced.

Another characteristic of this embodiment is that the bottom inclined face 113 configuring the bottom face of the casing 100 is an inclined face that rises in the forward direction. Because, on a conventional apparatus of this type, the functional part is concentrated on the vertical face on the front of the casing to make the apparatus low profile as described above, it is difficult to provide an intake on the front for cooling the internal of the apparatus. Therefore, an efficient cooling passage cannot be formed because the casing 100 takes in air through the intake provided on the sides, supplies air via the bent cooling passage, and exhausts air through the vent provided on the back.

In contrast, an intake 112 is formed on the bottom inclined face 113 with a high open area ratio in this embodiment. This structure allows a straight cooling passage to be formed without affecting the low profile design. This straight cooling passage allows the apparatus to take in sufficient air from the forward direction, cool the internal units, and exhaust air from the back, thereby increasing the cooling efficiency.

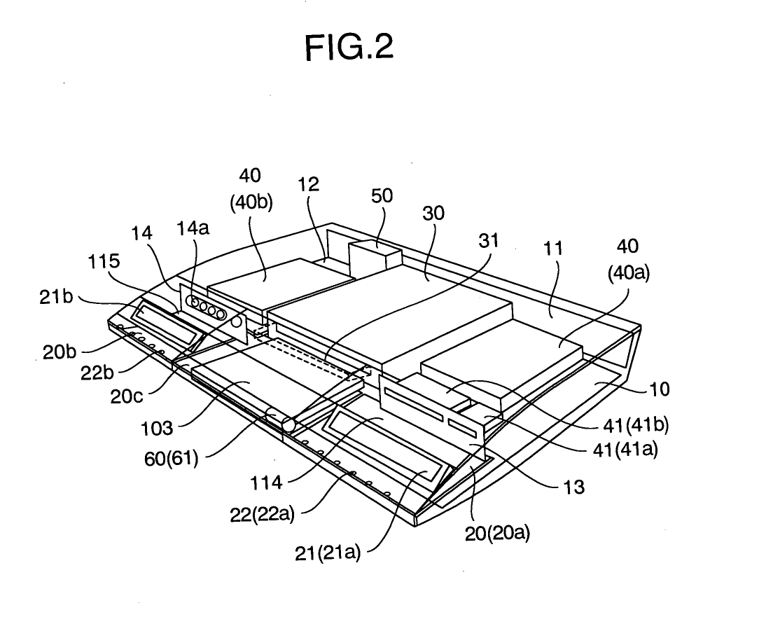

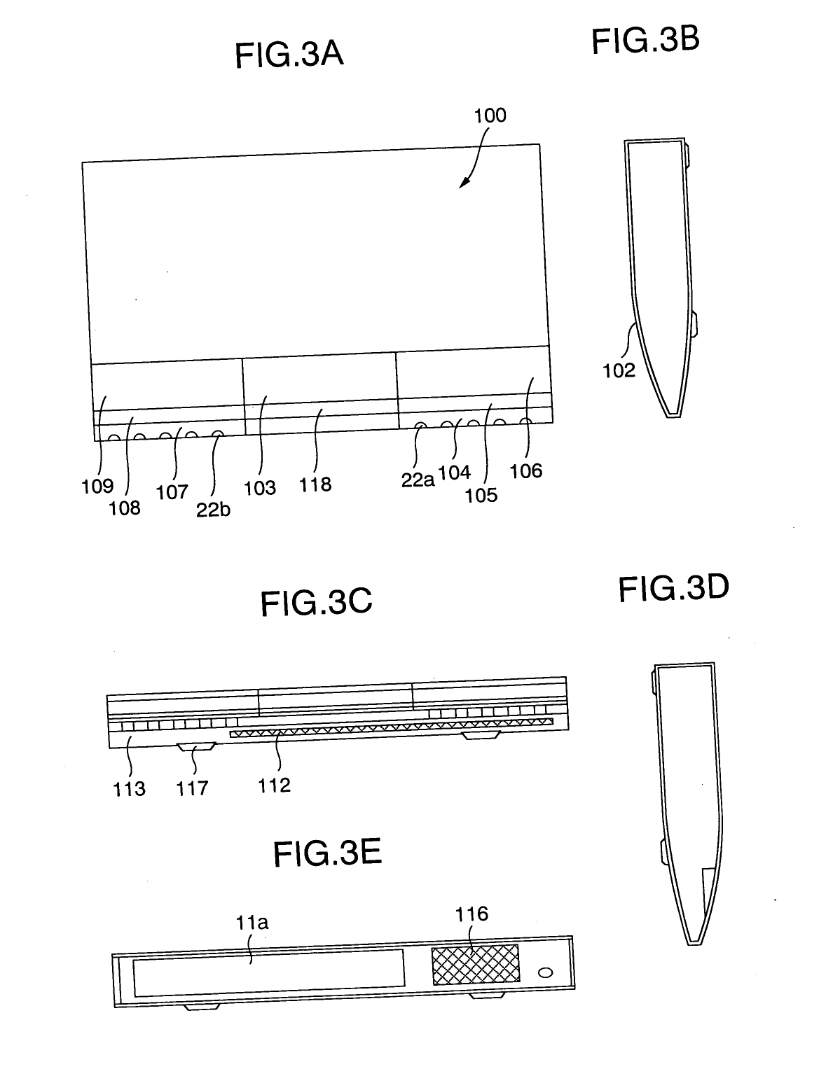

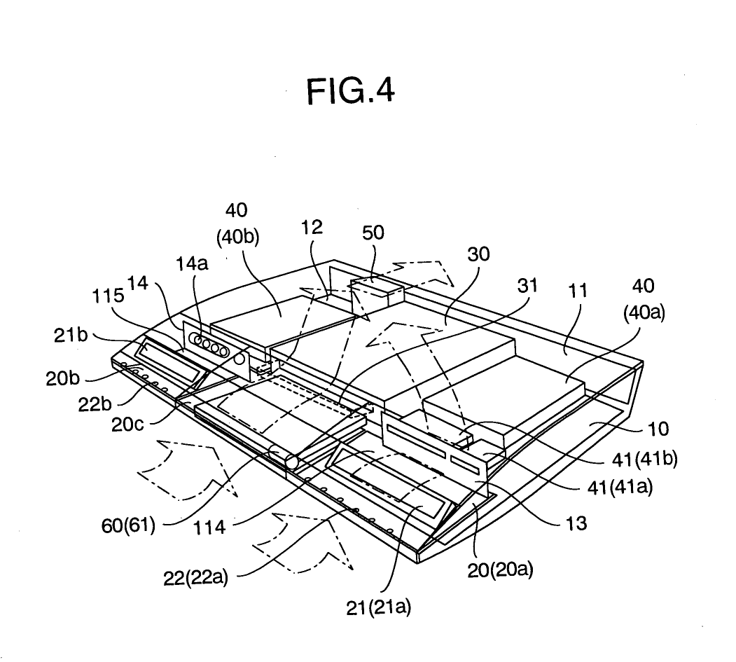

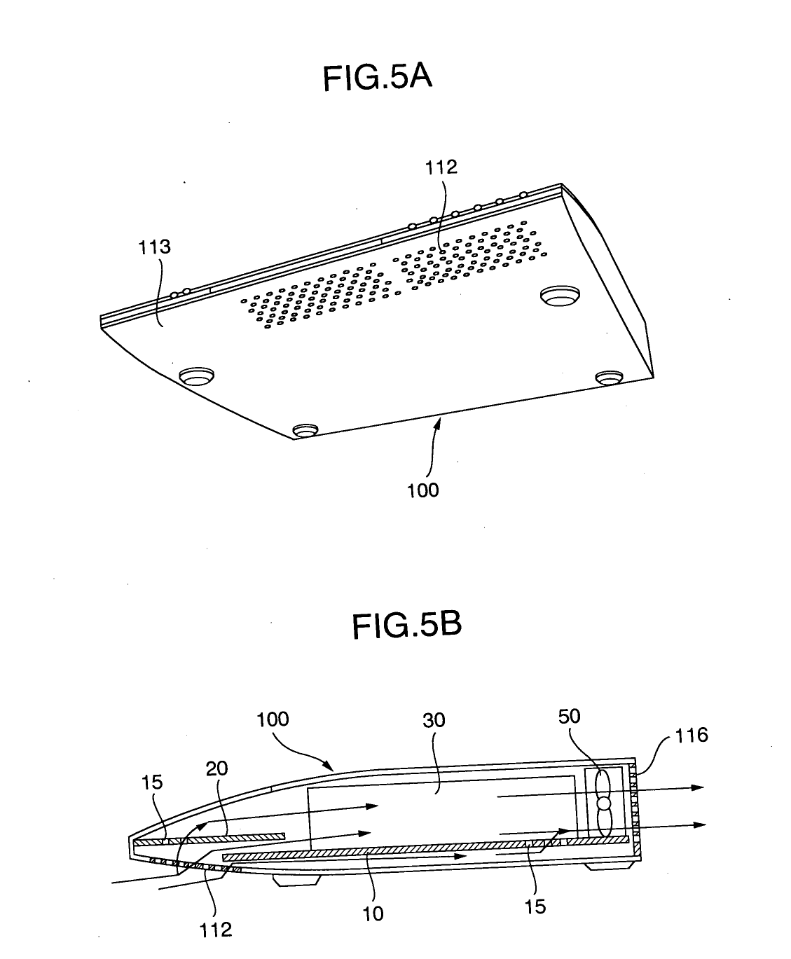

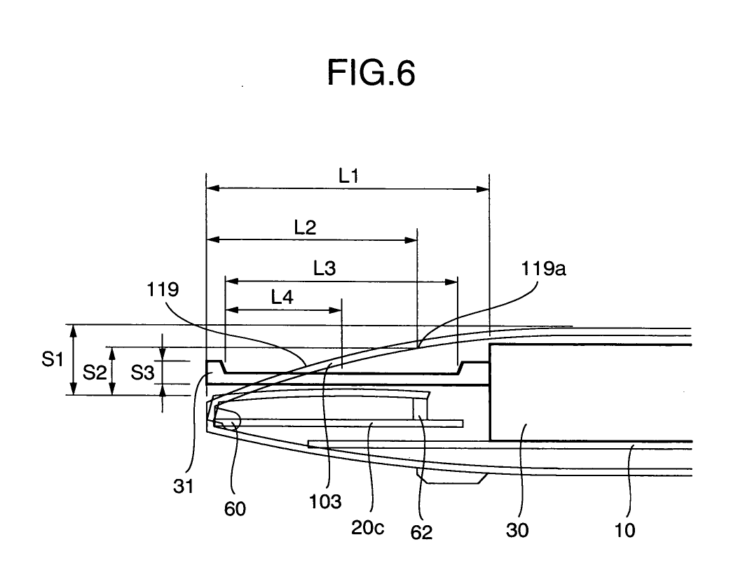

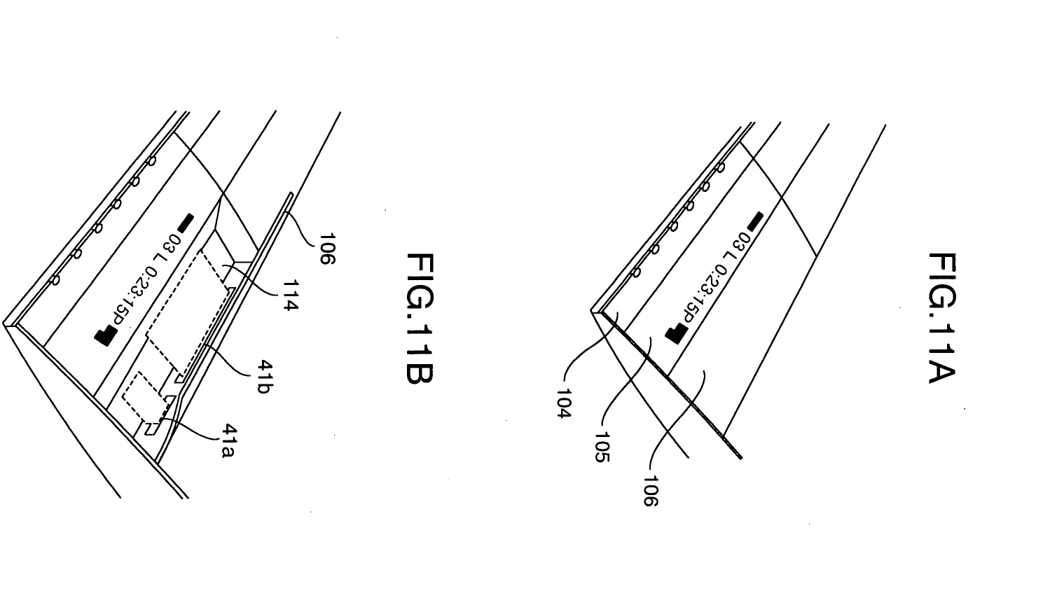

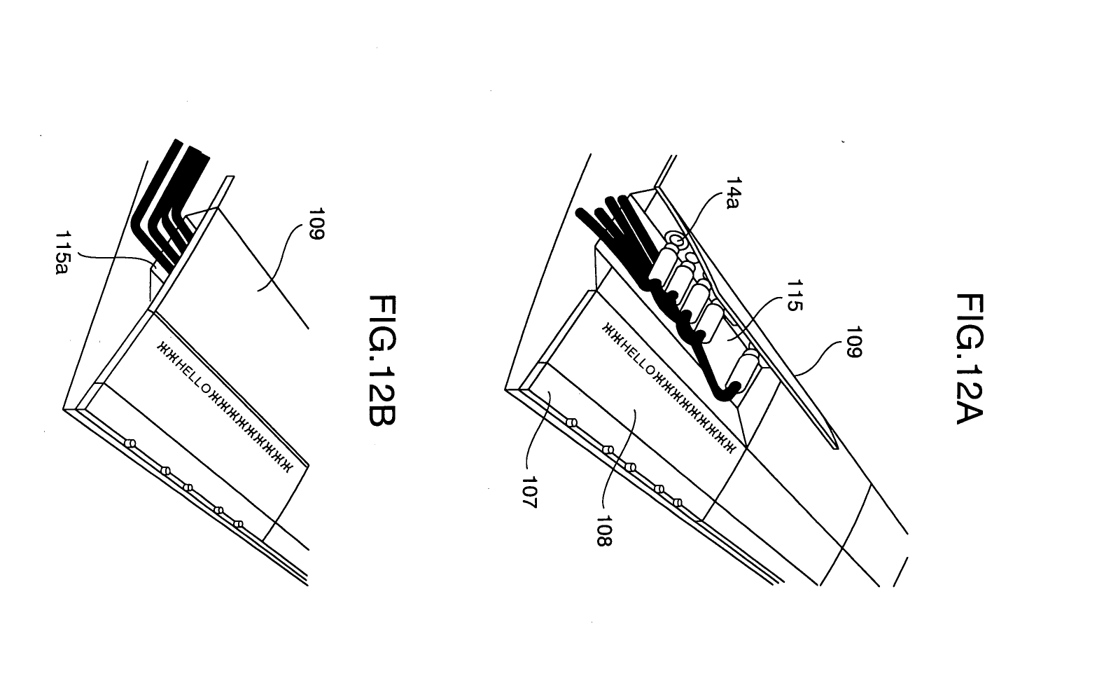

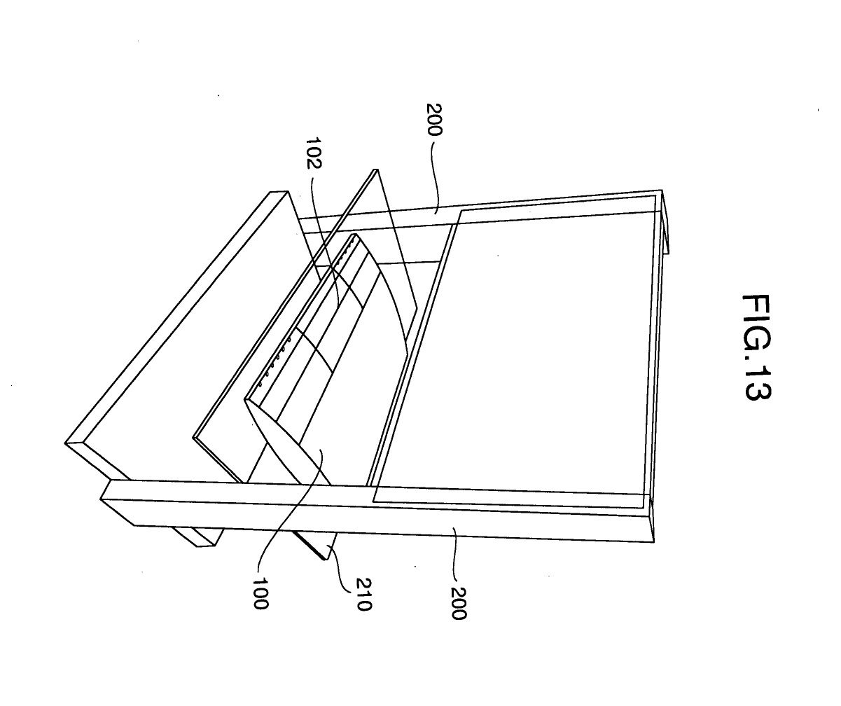

The following describes the DVD recorder in this embodiment more in detail with reference to FIG. 2 to FIGS. 17A-17C. FIG. 2 is a diagram showing the layout of the internal units, FIGS. 3A-3E are external views, FIG. 4 and FIGS. 5A-5B are diagrams showing the cooling passage, FIG. 6 to FIG. 10 are diagrams showing a door driving unit, FIGS. 11A-11B and FIGS. 12A-12B are diagrams showing the second and third doors, and FIG. 13 to FIGS. 17A-17C are diagrams showing the installation state.

First, the following describes the layout of the internal units of the DVD recorder with reference to FIG. 2. FIG. 2 is a perspective view showing the layout of the internal units of the DVD recorder.

Referring to FIG. 2, a main board 10 is provided at the bottom of the casing 100 in this embodiment, and the internal units described below are arranged on this main board 10. That is, an operation board 20 is arranged before the main board 10 with its part overlapped on the main board 10 with a difference in height. This operation board 20 is arranged in a position higher than the main board 10 with its back part overlapped on the main board 10 and with its front protruded forward. In this embodiment, the arrangement of this two-stage configuration board forms the top inclined face 102, which is opposed to the front of the casing 100 and which falls in the forward direction, and the bottom inclined face 113 that rises in the forward direction, thus making the DVD recorder unique in the external shape that gets acute in the forward direction.

In this embodiment, the operation board 20 is divided horizontally into three: a first operation board 20a, a second operation board 20b, and a third operation board 20c.

The first operation board 20a, provided in one side, has the following three components: a first operation part 22a in the front, a first display part 21a in the center, and a sub storage unit installation board 13 in the back. The first operation part 22a corresponds to the first operation panel 104, and the first display part 21a corresponds to the first display panel 105, respectively. The first display part 21a and the sub storage unit installation board 13 are installed with a space between them, and a first concave part 114 formed in the space between those two members is used as a workspace where a recording medium is inserted into the sub storage unit installation board 13.

In this embodiment, the sub storage unit installation board 13 has a sub recording/reproducing unit 41, composed of a first sub recording/reproducing unit 41a and a second sub recording/reproducing unit 41b, for reading data from, and writing data to, a recording medium in different modes. The first concave part 114 is a workspace where a recording medium is inserted into one of multiple recording medium insertion slots of the sub recording/reproducing unit 41. The first concave part 114 has its top covered by the second door 106.

On the other hand, the second operation board 20b, provided in the other side, is structured in the same way as the first operation board 20a. That is, the second operation board 20b has the following three components: a second operation part 22b in the front, a second display part 21b in the center, and a sub external terminal board 14 in the back. The second operation board 20b corresponds to the second operation panel 107, and the second display part 21b corresponds to the second display panel 108, respectively. The second display part 21b and the sub external terminal board 14 are installed with a space between them, and a second concave part 115 formed in the space between those two members is used as a terminal storage space where connectors are installed on the sub external terminal board 14.

In this embodiment, the sub external terminal board 14 has multiple sub external terminal parts 14a composed of audio terminals and video terminals. The second concave part 115 is a workspace where connectors are installed on the sub external terminal parts 14a on the sub external terminal board 14 or is a storage space where the installed connectors are stored. This second concave part 115 has its top covered by the third door 109.

The third operation board 20c, provided between the first operation board 20a and the second operation board 20b, has a door driving unit 60 with a driving motor 61 thereon. The first door 103 is removably installed on the door driving unit 60.

A disc recording/reproducing unit 30 is provided behind the third operation board 20c. When the back part of the first door 103 is pushed downward via the door driving unit 60, a difference in height (disc entrance 111) is formed by this operation to allow the tray 31 of the disc recording/reproducing unit 30 to be ejected or stored via this disc entrance 111.

In this embodiment, the operation board 20 is provided before the main board 10 with their parts overlapped each other, and a vertical main external terminal board 11 is provided behind the main board 10. Multiple recording/reproducing units and a power supply 12 are provided in the installation space between the main external terminal board 11 and the operation board 20. In this embodiment, the depth of the installation space is set to the depth size of the largest unit of those installed in the installation space, that is, to the depth size of the disc recording/reproducing unit 30.

In this embodiment, a first internal recording/reproducing unit 40a and a second internal recording/reproducing unit 40b, both of which are shorter than the disc recording/reproducing unit 30 in the depth size, are provided in both sides of the disc recording/reproducing unit 30 installed separately in the center in order to increase the internal installation efficiency of the installation space. The first internal recording/reproducing unit 40a, which is provided behind the sub storage unit installation board 13, is shifted backward considering the depth size of the sub recording/reproducing unit 41 that is installed on the sub storage unit installation board 13.

On the other hand, the second internal recording/reproducing unit 40b, which is provided behind the sub external terminal board 14, is provided adjacent to the sub external terminal board 14 because the depth size of the sub external terminal part 14a installed on the sub external terminal board 14 is not so long. In this embodiment, the space behind the second internal recording/reproducing unit 40b, formed by the arrangement between the sub external terminal board 14 and the second internal recording/reproducing unit 40b that are provided adjacent each other, is used to install the power supply 12 and a fan 50.

In this embodiment, the first internal recording/reproducing unit 40a and the second internal recording/reproducing unit 40b are internal recording/reproducing units 40 on which a disc of the same size is used and whose casing size is the same. When the power supply 12 requiring a large power is installed, the size of the second internal recording/reproducing unit 40b is made smaller than that of the first internal recording/reproducing unit 40a.

Just as described, the operation board 20, which is vertical in the prior art, is provided horizontally between the front part of the casing top 101 of the casing 100 and the main board 10 in this embodiment. This structure gives an internal installation space that has a cross section, basically similar in shape to a right-angled triangle extending from the front to the back, above the operation board 20.

In this embodiment, the internal installation space with the cross section of a right-angled triangle is used efficiently in such a way that an operation part 22 is provided in the least spacious front part, the work/storage space where the sub recording/reproducing unit 41 and the sub external terminal part 14a are connected or stored is formed in the most spacious back part, and a display part 21 is provided in the space in the center.

The most characteristic point is that the movement path of the tray 31 is formed using the internal installation space with the cross section of a right-angled triangle. In this embodiment, the first door 103 moves from the hypotenuse to the horizontal side of the right-angled triangle in the internal installation space. Therefore, the gap with the height of the vertical side created by the movement of the first door 103 from the hypotenuse to the horizontal side can be used as the disc entrance 111.

In this embodiment, the disc recording/reproducing unit 30 is provided behind the disc entrance 111 to store or eject the tray 31 via the disc entrance 111. At this time, though the tray 31 moves above the first door 103, the top part of the first door 103 has a concave shape with projections on both sides and therefore protects the tray 31 from external damage. In addition, the projections in both sides of the first door 103, which becomes lower as it goes near the front, reduces the possibility of a mounting failure that will occur when mounting a disc with the tray 31 ejected.

Partial overlapping between the main board 10 and the operation board 20 reduces the depth size and increases the wiring efficiency. In addition, this arrangement increases the cooling efficiency as will be described later.

Because the operation board 20 is horizontal in this embodiment, the units can be arranged in the internal installation space behind the operation board 20 with consideration for a difference in the unit sizes to increase both the internal installation efficiency and the cooling efficiency.

Although the operation board 20 is divided into multiple boards in this embodiment, the present invention is not limited to this configuration. Although the units are arranged symmetrically with the disc recording/reproducing unit 30 in the center in this embodiment, the present invention is not limited to this configuration. It is also possible to provide the disc recording/reproducing unit 30 in one of the sides.

Next, with reference to FIGS. 3A-3E, the following describes the external views of the DVD recorder. FIG. 3A is a top view, FIG. 3B is a right side view, FIG. 3C is a front view, FIG. 3D is an enlarged side view, and FIG. 3E is a rear view. The side views are illustrated vertically because of space limitations.

Referring to FIGS. 3A-3E, the front part of the low profile casing 100 is acute when viewed from the sides in this embodiment. The first door 103 is provided in the center of the top inclined face 102 that is inclined downward in the forward direction. The first operation panel 104, the first display panel 105, and the second door 106 are provided in one side, and the second operation panel 107, the second display panel 108, and the third door 109 are in the other side, so that they are in line with the depth of the first door 103. The first operation panel 104 and the second operation panel 107, the first display panel 105 and the second display panel 108, and the second door 106 and the third door 109 each continue horizontally and have the same depth.

In this embodiment, the first display panel 105 and the second display panel 108 are made of a dark transparent member to increase the visibility of the display part 21 that is provided internally. At the same time, providing a continuous, dark transparent member 118 in the center of the first door 103 to join together the first display panel 105 and the second display panel 108, which are in both sides, makes the multiple zones appear as if they were continued, thus making the structure simple and ensuring good design.

In this embodiment, the operation part 22 composed of multiple switches is at the acute front edge of the casing to allow the user to push them from the front. The operation part 22 is divided horizontally into two. For example, the DVD recording/reproducing switches are provided in the first operation part 22a in one side, and the tuner and various switches are provided in the second operation part 22b in the other side, to make the recorder easy to use. The basic operation of the DVD recorder in this embodiment is controlled by a separate remote control. Therefore, the operation part 22 is used when the remote control is not available for use or when the user wants to do a direct operation. Therefore, small switches are at the front edge of the operation part, which is acute, to prevent an operation error when a disc is mounted or removed. Normally, the switches look as a part of the casing and are pushed downward when operated.

The operation part 22 should not be difficult to use just because it is less frequently used. Thus, the DVD recorder in this embodiment has the bottom inclined face 113 that raises the front edge of the casing bottom. Because the switch panel of the operation part 22 is kept high because of this structure and is at the acute front edge, operability is increased while reducing operation errors.

In this embodiment, the display part 21 is also divided horizontally into two. This structure allows the major status, such as the recording time or the clock display, to be displayed in first display part 21a, and the other information to be displayed in the second display part 21b that is the other display, making the display easier to understand.

In this embodiment, the external connection terminals are provided in two separate locations. Permanently connected terminals are connected to a main external connection terminal part 11a on the rear, and temporarily connected terminals are connected to the sub external terminal part 14a inside the third door 109.

A vent 116 is provided on the rear of the casing 100 to allow air, taken in from the intake 112 on the bottom inclined face 113, to be forced to exhaust via the fan 50. The numeral 117 indicates the foot provided on the bottom of the casing 100.

Next, the internal cooling structure will be described with reference to FIG. 4 and FIGS. 5A-5B. FIG. 4 is an internal perspective view showing the cooling passage. FIGS. 5A-5B are diagrams showing the cooling passage structure. FIG. 5A is a bottom perspective view of the DVD recorder, and FIG. 5B is a longitudinal cross section view showing the cooling passage.

Referring to FIG. 4 and FIGS. 5A-5B, the cooling passage in this embodiment has a structure in which air is forced to be taken in from the intake 112 provided on the bottom inclined face 113 via the fan 50 to cool the internal units and the air is exhausted from the vent 116. Because the main board 10 and the operation board 20 are installed, one on top of the other, with a space between them in this embodiment as shown in FIG. 5B, the air taken in from the intake 112 can be circulated through the space between the main board 10 and the operation board 20. In addition, the main board 10 and the operation board 20 have multiple ventilating holes 15 through which air is taken in to cool the top of the operation board 20 and the bottom of the main board 10.

As shown in FIG. 4, in the DVD recorder in this embodiment, the air taken into the casing from the intake 112 via the fan 50 cools, for example, the first operation board 20a, sub recording/reproducing unit 41, first internal recording/reproducing unit 40a, or surrounding part on the main board 10, cools the third operation board 20c, disc recording/reproducing unit 30, or surrounding part on the main board 10, and cools the second operation board 20b, sub external terminal part 14a, second internal recording/reproducing unit 40b, and the surrounding part on the main board 10. After that, the air is collected around the power supply 12 with the highest calorific value. The air collected around the power supply 12 can be forced to exhaust externally by means of the fan 50.

Just as described, the cooling passage in this embodiment, formed straightly from the front to the rear of the casing 100, increases the cooling efficiency. In addition, the intake 112, which is large in size and formed on the bottom inclined face 113 to hide it from the user, ensures a better open area ratio and good design. The straight cooling passage also eliminates the need for the intakes 112 to be provided on both sides or on the top of the casing that is usually seen by the user, thus ensuring good design. Even if DVD recorders are stacked, this cooling structure prevents the cooling passage from being blocked and thus allows DVD recorders to be used in various installation environments.

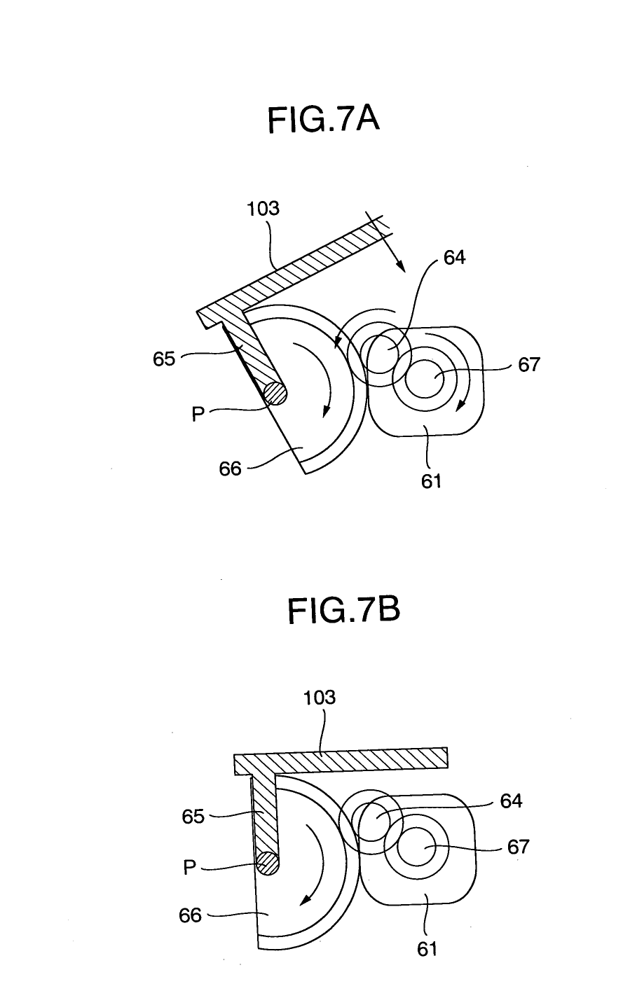

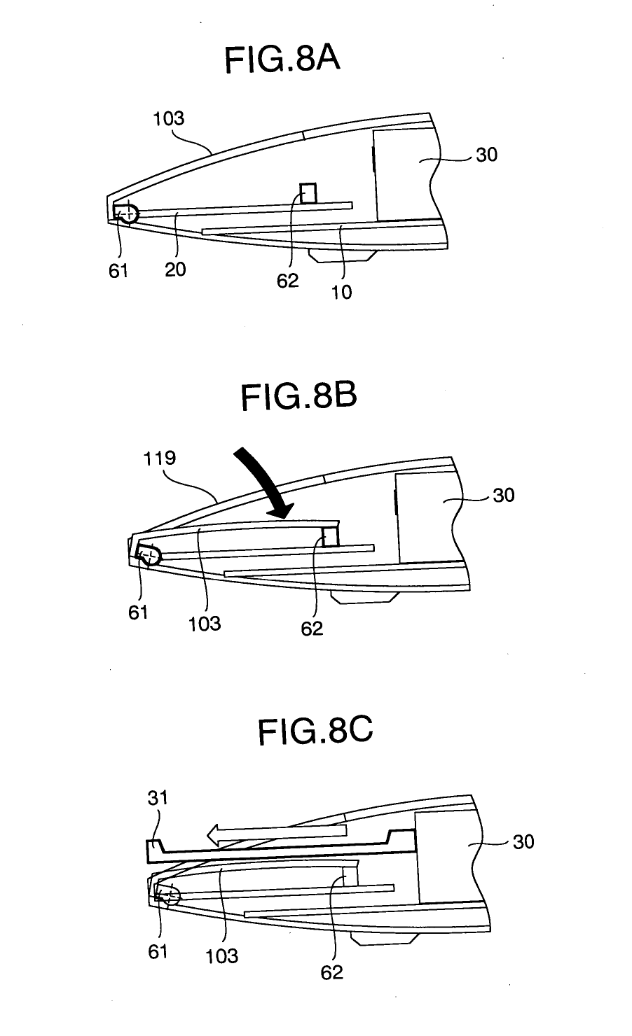

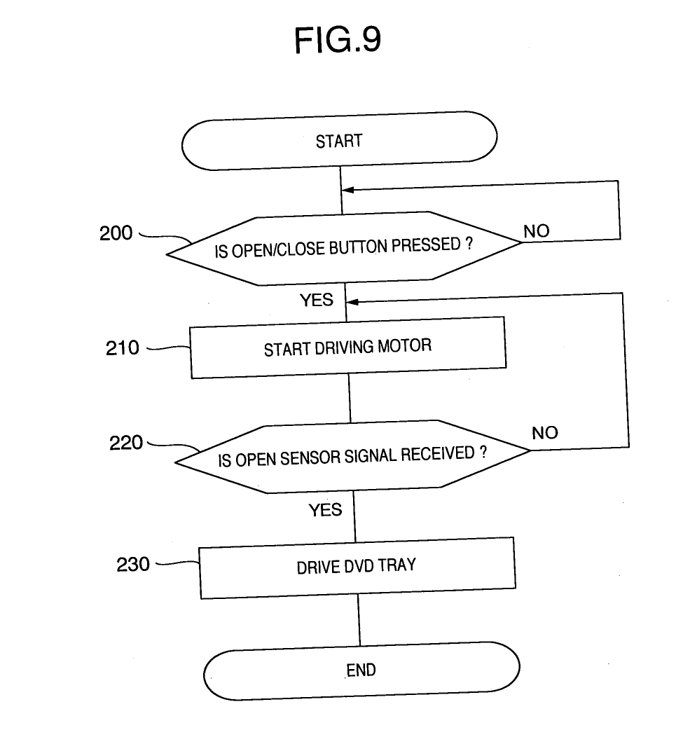

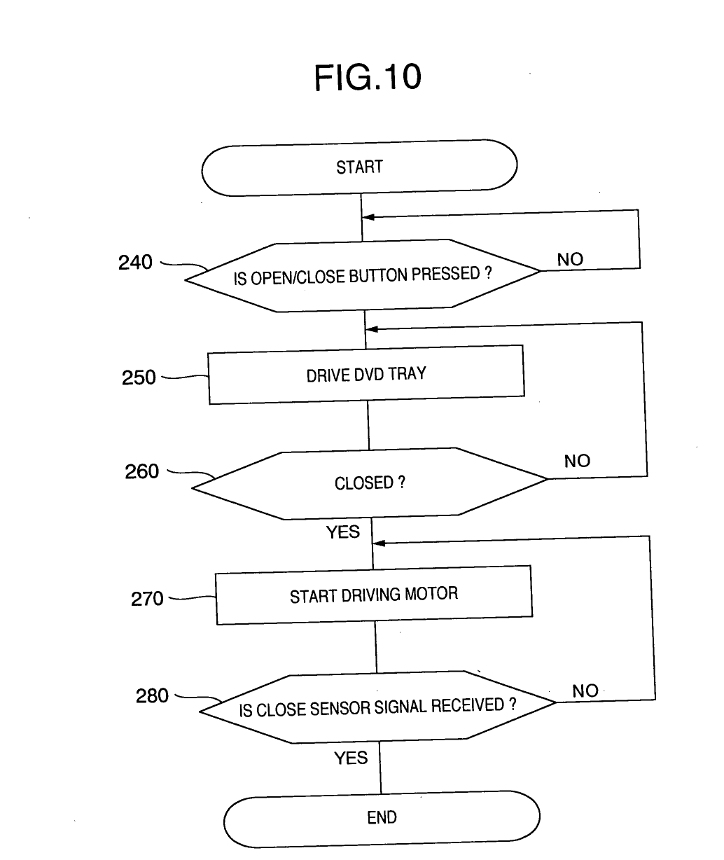

Next, the following describes the door driving unit 60 in detail with reference to FIG. 6 to FIG. 10. FIG. 6 is a diagram showing the general cross section of the tray movement path. FIGS. 7A-7B are diagrams showing the general structure of the door driving unit. FIG. 7A is a diagram showing the general cross section when the disc entrance is closed, and FIG. 7B is a diagram showing the general cross section when the disc entrance is opened. FIGS. 8A-8C are diagrams showing the operation process of the door driving unit. FIG. 8A is a diagram showing the cross section when the first door is closed, FIG. 8B is a diagram showing the cross section when the first door is opened, and FIG. 8C is a diagram showing the cross section when the tray is ejected. FIG. 9 is a flowchart showing the tray ejection operation. FIG. 10 is a flowchart showing the tray storing operation.

Referring to FIG. 6, in this embodiment, the disc recording/reproducing unit 30 is provided on the main board 10, and the third operation board 20c, on which the door driving unit 60 and an open sensor 62 are provided, is in a position before and above the main board 10. The disc recording/reproducing unit 30 has the tray 31, which is stored or ejected, above the third operation board 20c via the driving unit not shown.

As shown in FIGS. 7A and 7B, a protruded rotational axis support 65 is formed inside of the front end of the first door 103 in this embodiment. A rotational axis P is formed at the front end of the rotational axis support 65, and this rotational axis P is installed rotatably on the door driving unit 60 installed in the second operation part 22b. The door driving unit 60 comprises a semicircle gear 66 installed on the rotational axis P, the driving motor 61, and a gear shifter 64 (gear) mechanically coupling a gear 67, installed on the rotational axis of the driving motor 61, to the semicircle gear 66.

FIG. 7A is a diagram showing the state when the first door 103 is closed. When the driving motor 61 is rotated in the arrow direction in the state shown in FIG. 7A, the turning force is transmitted to the semicircle gear 66 via the gear shifter 64 to cause the semicircle gear 66 to turn in the arrow direction. Then, the rotational axis support 65, which is coupled to the semicircle gear 66, is rotated on the rotational axis P to pull down the back part of the first door 103 to place the first door 103 in the state shown in FIG. 7B. The operation to close the first door 103 is accomplished by rotating the driving motor 61 in the reverse direction.

Returning to FIG. 6, in this embodiment, the first door 103 has the length of L2 in the depth direction and, when the first door 103 is opened, the first door 103 becomes approximately parallel to the third operation board 20c. When the first door 103 is opened, the top face of the first door 103 is lower than the casing top 101 of the casing 100 by the height of S1. Thus, when the first door 103 is opened, the disc entrance 111 with a gap 111a with the height of S2 is opened between the a back end 119a of an opening 119, opened by lowering the back end of the first door 103, and the top face of the first door 103. The height S2 of this gap 111a is set greater than the thickness S3 of the tray. Therefore, opening the disc entrance 111 allows the tray 31 to be stored or ejected above the first door 103 via the gap 111a.

In this embodiment, the tray 31 is designed in such a way that the tray can be ejected for the length of L1 from the disc recording/reproducing unit 30 and, when it is ejected, its front end is within the project area of the first door 103. In addition, the tray 31 has a disc setting part 31a, L3 in length, on its top, and this disc setting part 31a is designed in such a way that at least first half of the disc setting part 31a (length L4 that is the half of L3) is exposed from the opening 119.

This structure allows at least the first half of the disc setting part 31a, that is, at least the half of a DVD or a CD, to be exposed from the opening 119 when the tray 31 is ejected, making the DVD or the CD easier to be inserted or ejected.

Although the movement path of the tray 31 is set within the project area of the first door 103 in this embodiment, the embodiment gives the same effect if the tray is approximately within the top face of the first door 103 even if the front end of the tray 31 runs off a short distance beyond the front end of the first door 103.

Next, with reference to the operation flowcharts in FIG. 9 and FIG. 10, the following describes the storing/ejection control of the tray 31 based on FIGS. 8A-8C. In this embodiment, the microcomputer (not shown) installed on the main board 10 controls the general operation of the DVD recorder. Because the disc recording/reproducing unit 30 is a self-controlling unit, the microcomputer (not shown) installed in this unit controls the operation of the driving unit of the tray 31 and the recording/reproducing mechanism. Therefore, the microcomputer of this DVD recorder issues the control signal to the microcomputer of the disc recording/reproducing unit 30 to put the disc recording/reproducing unit 30 under control. Unless otherwise stated, the microcomputer refers to the microcomputer installed on the main board 10 in the description below.

First, with reference to FIGS. 8A-8C and FIG. 9, the following describes the control operation when the tray 31 is ejected. In this embodiment, the microcomputer monitors if the open/close button (not shown) provided in the operation part 22 is pressed. If the open/close button is pressed (step 200), the microcomputer starts the driving motor 61 and keeps the driving motor rotating from the time indicated by the state in FIG. 8A to the time indicated by the state in FIG. 8B in which the signal is issued from the open sensor 62 (step 210). The open sensor 62 issues the signal when the back end of the first door 103 touches the open sensor 62 as shown in FIG. 8B. Upon receiving the signal from the open sensor 62, the microcomputer stops the driving motor 61 and issues the signal, which indicates the ejection operation of the tray 31, to the microcomputer of the disc recording/reproducing unit 30 (step 220). Upon receiving the operation signal, the microcomputer of the disc recording/reproducing unit 30 performs the operation to eject the tray 31 into the forward direction and, when the ejection operation of the tray 31 is completed as shown in FIG. 8C, sends the notification to the microcomputer to indicate that the operation is completed (step 230).

Next, the following describes the storing operation of the tray 31 with reference to FIGS. 8A-8C and FIG. 10. The microcomputer monitors if the open/close button is pressed in the state shown in FIG. 8C (step 240). If the open/close button is pressed, the microcomputer notifies a signal to the microcomputer of the disc recording/reproducing unit 30 to request it to store the tray 31. Upon receiving the notification, the microcomputer of the disc recording/reproducing unit 30 performs the storing operation of the tray 31 (step 250) and, when the tray 31 is stored and the state indicated by FIG. 8C is changed to the state indicated by FIG. 8B, sends a notification to the microcomputer to indicate that the storing operation of the tray 31 is completed (step 260). Upon receiving the completion notification from the microcomputer of the disc recording/reproducing unit 30, the microcomputer rotates the driving motor 61 in the reverse direction (step 270). When the signal is received from a close sensor 63 (not shown) provided near the opening 119, the microcomputer stops the driving motor 61 (step 280).

Although the opening/closing of the first door 103 is sensed by providing the open sensor 62 and the close sensor 63 in this embodiment, the present invention is not limited to this structure. For example, it is also possible to sense the load current of the driving motor 61 to check the open/close state.

Although the door driving unit 60 using the driving motor 61 is described in this embodiment, the present invention is not limited to this structure.

In addition, if a condition that blocks the operation of the tray 31 is found in the driving unit of the tray 31 when the tray 31 is ejected or stored, the microcomputer of the disc recording/reproducing unit 30 returns the tray 31 to the operation start point and notifies the content of the condition to the microcomputer provided on the main board 10. This reduces errors that may occur during the operation of the first door 103 and the tray 31.

Next, with reference to FIGS. 1A-11B, the following describes the structure of the surrounding of the sub recording/reproducing unit 41. FIG. 11A is an external view of the state in which the second door 106 is closed, and FIG. 11B is an external view of the state in which the second door 106 is opened.

In this embodiment, the first concave part 114 is formed inside the second door 106, and the medium insertion slots of the first sub recording/reproducing unit 41a and the second sub recording/reproducing unit 41b are provided on the wall behind the first concave part 114. The second door 106 can be opened by lifting its front end with the back end as the rotational axis. Therefore, in the state shown in FIG. 11B in which the second door 106 is opened, a recording medium can be inserted or removed into or from the medium insertion slot. On the other hand, in the state shown in FIG. 11A in which the second door 106 is closed, the top of the first concave part 114 is converted by the second door 106 to make the external view simple with no irregularity.

Next, with reference to FIGS. 12A-12B, the following describes the structure of the surrounding of the sub external terminal part 14a. FIG. 12A is an external view of the state in which the third door 109 is opened, and FIG. 12B is an external view of the state in which the third door 109 is closed.

In this embodiment, the second concave part 115 is formed inside the third door 109, and the sub external terminal part 14a composed of multiple terminals is provided on the back wall of the second concave part 115. The third door 109 can be opened by lifting its front end with the back end as the rotational axis. Therefore, in the state shown in FIG. 12A in which the third door 109 is opened, a connector can be installed or removed on or from the sub external terminal part 14a. The second concave part 115 is spacious enough to connect connectors to the sub external terminal part 14a and to store the connections.

On the other hand, in the state shown in FIG. 12B in which the third door 109 is closed, the side wall of the second concave part 115 has an opening 115a to allow the connection codes of the connectors to be drawn out via the opening 115a even if the third door 109 is closed. Therefore, the top of the second concave part 115 can be covered by the third door 109 to make its external view simple with no irregularity. In addition, because the connection cords of the connectors are drawn out from the side of the casing 100, the connection cords are not apparently visible and the neatness is kept.

Next, the following describes various installation states of the DVD recorder with reference to FIG. 13 to FIGS. 17A-17C.

First, the following describes a DVD recorder mounted in a TV rack with reference to FIG. 13. FIG. 13 is a diagram showing a DVD recorder mounted on a TV rack. A flat TV such as the one shown in FIG. 13 is the most popular TV today. Such a large flat TV is mounted, not on a standard box-shaped rack, but on an open TV stand. For example, in the embodiment shown in FIG. 13, the flat TV is supported by a pair of column supports 200 on both sides with a table 210, made of a transparent member such as glass, provided at the intermediate position of the column supports 200, and the DVD recorder (casing 100) is placed on this table 210. A DVD recorder used with such a TV is completely exposed to view. Especially, the top front part of the casing 100 is seen most by the user.

The DVD recorder in this embodiment has the most of the functional parts concentrated in a part that is most seen by the user, that is, on the top inclined face 102, thus increasing visibility and operability and ensuring good design.

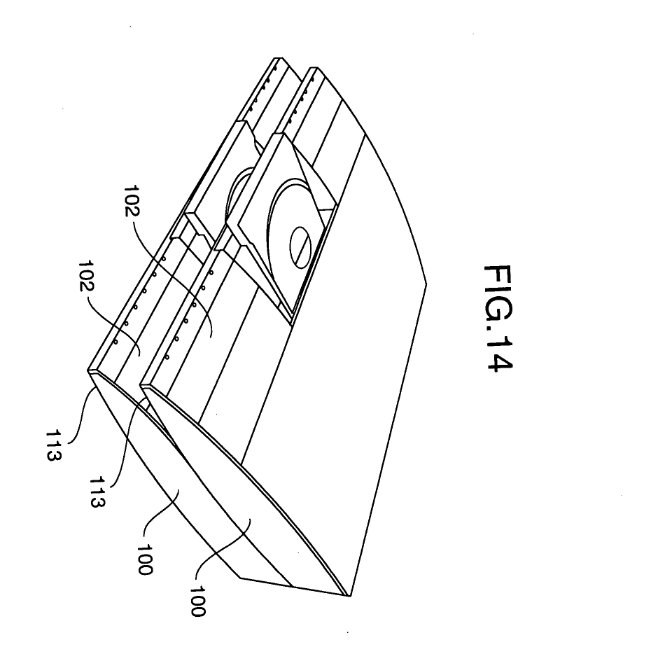

Next, with reference to 14, the following describes an example of installation in which the same types of DVD recorders are stacked. Referring to FIG. 14, the back part of the casing 100 is box-shaped, and the font part is made acute by the top inclined face 102 and the bottom inclined face 113 in this embodiment as described above. Therefore, even if two DVD recorders each with such a casing 100 are stacked, the top inclined face 102 of the lower DVD recorder is inclined downward and the bottom inclined face 113 of the upper DVD recorder is inclined upward, with the result that the visibility and the operability of the top inclined face 102 of the lower DVD recorder is not affected much by the upper DVD recorder.

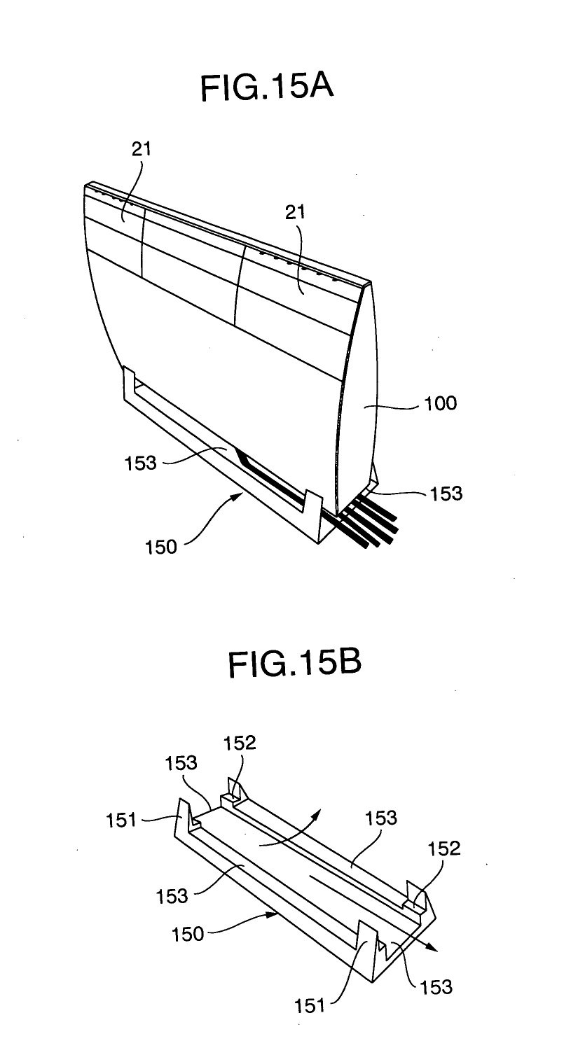

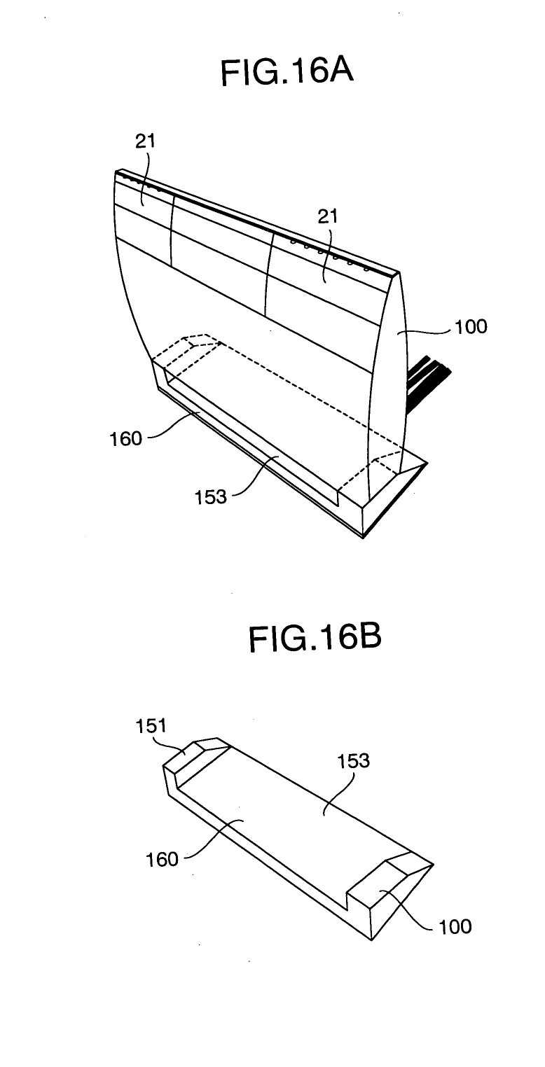

Next, with reference to FIGS. 15A-15B and FIG. 16A-16B, the following describes the vertical installation where the back face of the casing is placed on the floor. FIGS. 15A and 16A are external view of the overall recorder, and FIGS. 15B and 16B are external view of the holder.

In the embodiment shown in FIGS. 15A-15B, the content of the display part 21 can be displayed upside down through the operation of the display part 21. Switching the display part 21 in this way enables the vertical installation posture of the casing 100 with the back face on the floor as shown in FIG. 15A.

In this installation posture, a holder 150 is used because the back face of the casing cannot be placed directly on the floor. This trapezoidal-shaped holder 150 has a top-face, which is one size larger than the back face of the casing 100, with supports 151 in the four corners for supporting the casing 100. The supports 151 have casing supports 152 at their middle positions, one for each, to support the casing 100 with a square gap 153 below the casing 100. This structure allows the cords to be drawn out into the rear side or both side, and the air to be exhausted through the gap 153, even if the casing 100 is installed as shown in FIG. 15A.

FIGS. 16A-16B show an embodiment in which a holder 160 is used that forms the gap 153 in both longitudinal sides of the casing 100. The holder 160 in this embodiment has the support 151 on both sides in the longitudinal direction to allow the cords to be drawn out, or the air to be exhausted, into the rear side.

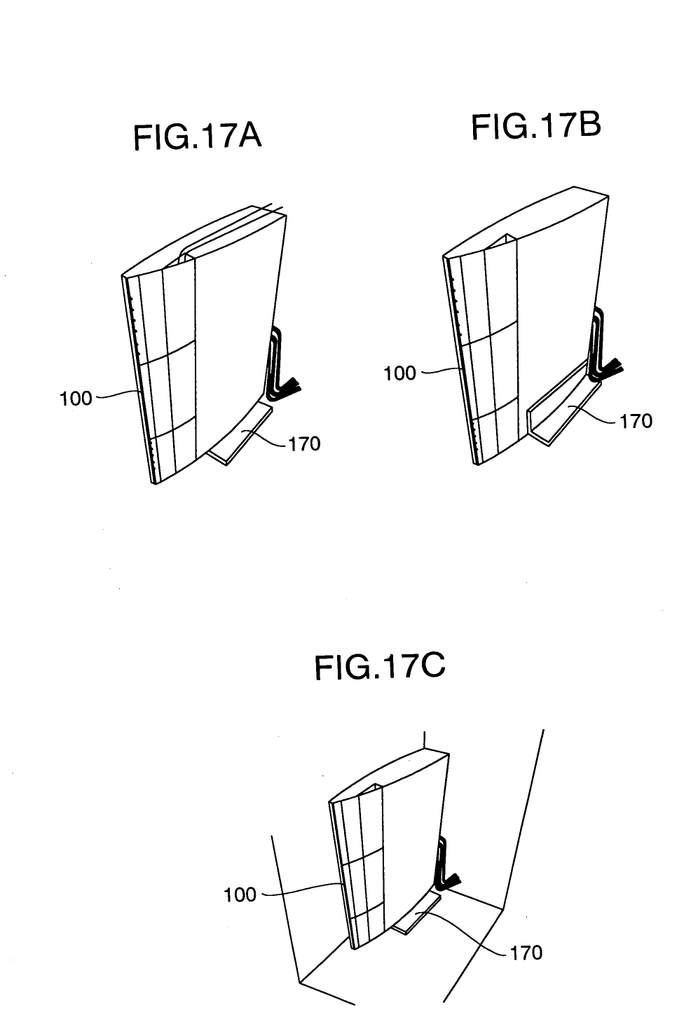

Next, with reference to FIGS. 17A-17C, the following describes the vertical installation where the side face of the casing 100 is placed on the floor. Because no intake is provided on the side of the casing 100 in this embodiment, the casing 100, supported by a separate holder 170 on the side, requires the least installation space. The holder 170 may be attached on the side of the casing 100 using screws as shown in FIG. 17A, or a holder that supports the casing 100 on both sides such as the one shown in FIG. 17B may be used.

In this installation posture, the casing 100 can be installed with the bottom adjacent to a wall or the side of a desk as show in FIG. 17C. Therefore, the casing 100 requires the least space and can be installed in any position.

The stacked installation of DVD recorders shown in FIG. 14 can also be applied to the installation shown in FIGS. 17A-17C. This installation posture gives the same operation effect as that in FIG. 14.

The information reproducing apparatus according to the present invention, which allows a disc to be mounted or removed via the tray, can be applied to various apparatuses that process video information, music information, and various other types of data.

It should be further understood by those skilled in the art that although the foregoing description has been made on embodiments of the invention, the invention is not limited thereto and various changes and modifications may be made without departing from the spirit of the invention and the scope of the appended claims.

1. An information reproducing apparatus that accepts a recording disc into the apparatus via an ejectable tray for reproducing information, wherein
an inclined face, which is inclined downward, is formed before a reproducing disc unit having the ejectable tray and a door is provided on said inclined face, said door configuring said inclined face when the door is closed, said door forming a movement path of said tray by lowering a back part of the inclined face inward when the door is opened.

2. The information reproducing apparatus according to claim 1 wherein
the movement path of said tray is formed above said door.

3. The information reproducing apparatus according to claim 2 wherein
the movement path of said tray is within a project area of said door.

4. An information reproducing apparatus wherein
an inclined face, which rises into a back direction, is formed on a front-top part of a casing and a reproducing disc unit having an ejectable tray is provided behind said inclined face and
a door is provided on said inclined face, said door configuring said inclined face when the door is closed, said door forming a movement path of said tray by lowering a back part of the inclined face inward when the door is opened.

5. The information reproducing apparatus according to claim 4 wherein
the movement path of said tray is formed above said door.

6. The information reproducing apparatus according to claim 5 wherein
the movement path of said tray is within a project area of said door.

7. An information reproducing apparatus that reproduces information from a recording disc inserted into a disc recording/reproducing unit provided inside a casing via an ejectable tray wherein
said casing has a low-profile, flat external shape whose depth size is longer than a height size and whose width size is longer than a depth size
a front of said casing comprises a top inclined face, which is inclined downward from a back to a front of a top of said casing, and a bottom inclined face which is inclined upward from a back to a front of a bottom of said casing and
said top inclined face at least has a door, said door configuring said top inclined face when the door is closed, said door forming a movement path of said tray by lowering a back part of said top inclined face into an inside of said casing when the door is opened.

8. The information reproducing apparatus according to claim 7 wherein
said casing has an operation part provided at a front end thereof and composed of a plurality of switches and
said operation part is exposed on said top inclined face.

9. The information reproducing apparatus according to claim 7 wherein
said casing has an intake formed on said bottom inclined face and a vent formed on a rear and communicating with said intake.

10. The information reproducing apparatus according to claim 7 wherein
said door has a first door provided in a center of said top inclined face, a second door provided in one side of said first door, and a third door provided in another side of said first door and
said first door configures said top inclined face when the first door is closed and forms the movement path of said tray by lowering the back part of said top inclined face into the inside of said casing when the first door is opened.

11. The information reproducing apparatus according to claim 10 wherein
said casing has a first concave part exposed when said second door is opened and
said second door configures said top inclined face when the second door is closed, and medium insertion slots, provided in said first concave part, are exposed when the second door is opened.

12. The information reproducing apparatus according to claim 10 wherein
said casing has a second concave part exposed when said third door is opened and
said third door configures said top inclined face when the third door is closed, and an external terminal part, provided in said second concave part, is exposed when the third door is opened.
